(19) United States
(12) Patent Application Publication
(10) Pub. No.: US 2012/0295230 A1
(43) Pub. Date: Nov. 22, 2012

(54) Interactive driver's educational video game system and method

(76) Inventor: Joseph C. Esposito, Whitehouse Station, NJ (US)

(21) Appl. No.: 13/068,801

(22) Filed: May 20, 2011

(51) Int. Cl. G09B 9/04

(52) U.S. Cl. 434/69

(57) ABSTRACT

An interactive driver's educational video game is utilized on a game system. The game comprises a game machine main body and at least one recording medium for storing program data therein. The game machine main body comprises at least one CPU, at least one bus and components connected thereto, at least one graphics data producing processor, at least one interface circuit, a main memory, a ROM, at least one expanding circuit, at least one parallel port/serial port, at least one drawing sound processor, at least one buffer, and at least one decoder. The game machine is appointed to be connected to a visual display monitor. The interactive driver's educational video game is stored on a medium. The interactive driver's educational video game comprises a player number entry means, player vehicle position means, player assignment means, variable insert means, and distance/destination means. Advantageously, the interactive driver's educational video game is used to educate drivers; especially inexperienced drivers and elderly drivers, on how to react to various driving situations in order to prevent automobile accidents and save lives.

### FIELD OF THE INVENTION

The present invention relates to an interactive driver educational video game and apparatus that provides a simulated driving scenario displayed on a game picture, and more particularly to an interactive driver educational video game that trains and educates drivers, such as beginner drivers, and/or provides an elderly driver with an assessment of his/her reflexes, vision and/or hearing; and which is implemented on a computer or video game system that simulates driving scenarios to expose a driver to real life situations on the road so that the young or inexperienced driver will become better equipped to react in driving scenarios that would likely be encountered in real world driving situations.

### DESCRIPTION OF THE PRIOR ART

Motor vehicle crashes are the leading cause of death for U.S. teens, accounting for more than one in three deaths in this age group. Centers for Disease Control and Prevention (CDC). Web-based Injury Statistics Query and Reporting System (WISQARS) [Online]. (2009); www.cdc.gov/injury/wisqars. [Cited 2009 Nov. 3]. In 2008 alone, nine teens ranging in age from 16 to 19 died daily from motor vehicle injuries. Per mile driven, this age group has been found to be four times more likely than older drivers to crash. It has further been found that 77% of crashes involving teenage drivers were the result of avoidable driver errors. www.safeteendriving.org/resources. Nearly half of all fatal car crashes involving teenage drivers are single-car vehicular accidents. Moreover, more than 60% of teens killed in car accidents were not wearing seat belts. According to the CDC, in 2008, roughly 3,500 teens in the United States aged 15-19 were killed and more than 350,000 were treated in emergency rooms for injuries suffered in motor-vehicle crashes.

Although young people ages 15-24 represent only 14% of the U.S. population, they account for 30% ($19 billion) of the total costs of motor vehicle injuries among males and 28% ($7 billion) of the total costs of motor vehicle injuries among females. Those teen drivers especially posing high motor vehicle crash risks include: males ages 15-19, teens driving with teen passengers, and newly licensed teens. The CDC has identified certain factors operative to place teen drivers at risk.

One factor involves the propensity of teens to underestimate dangerous situations or not be able to recognize hazardous situations. Another factor involves the reality that teens are more likely than older drivers to speed and allow shorter headway distance from the front of one vehicle to the rear of the next. Other factors involve teens driving under the influence, as that age group is particularly vulnerable to making poor decisions when it comes to drinking and driving.

Numerous game systems involving vehicle simulation have been conventionally proposed and used, but these game systems do not provide actual educational value because they fail to provide actual simulated driving scenarios that involve frequently encountered driving situations. There remains a need in the art for a driving game that utilizes real life scenarios, consequences of driving mistakes, and tests of driving skills to teach beginner drivers, young drivers, foreign drivers, and/or elderly drivers how to react to conditions encountered in real world driving situations.

### SUMMARY OF THE INVENTION

The present invention discloses an interactive driver's educational video game comprising a game appointed to be utilized on a game system comprising a game machine main body and at least one recording medium for storing program data therein, the game machine main body comprising at least one CPU, at least one bus and components connected therein, at least one graphics data producing processor, at least one interface circuit, a main memory, a ROM, at least one expanding circuit, at least one parallel port/serial port, at least one drawing sound processor, and at least one buffer, at least one decoder, the game machine being appointed to be connected to a visual display monitor. The interactive driver's educational video game is stored on a medium. The interactive driver's educational video game comprises a player number entry means, player vehicle position means, player assignment means, variable insert means, and distance/destination means. Advantageously, the interactive driver's educational video game is used to educate drivers and elderly drivers, particularly inexperienced drivers, on how to react in various driving situations in order to prevent automobile accidents and save lives.

Also provided is an interactive driver's educational video game method comprising the steps of: a) constructing a game system, the system comprising a game machine main body and at least one recording medium for storing program data therein, the game machine main body comprising at least one CPU, at least one bus and components connected therein, at least one graphics data producing processor, at least one interface circuit, a main memory, a ROM, at least one expanding circuit, at least one parallel port/serial port, at least one drawing sound processor, and at least one buffer, at least one decoder, the game machine being appointed to be connected to a visual display monitor; b) programming the interactive driver's educational video game comprising a player number entry means, player vehicle position means, player assignment means, variable insert means, and distance/destination means; and c) storing the interactive driver's educational video game on a medium.

### BRIEF DESCRIPTION OF THE DRAWINGS

The invention will be more fully understood and further advantages will become apparent when reference is had to the following detailed description of the preferred embodiments of the invention and the accompanying drawings, in which:

FIG. 1 is a block diagram showing a game system according to an embodiment of the present invention;

FIG. 2 illustrates a diagram of an embodiment of the subject invention wherein a passenger vehicle is provided;

FIG. 3a illustrates a flow chart of an embodiment of game parameters;

FIG. 3b illustrates a picture of the game;

FIG. 4 illustrates a snapshot of the subject driving game screen;

FIG. 5a illustrates a snapshot of the subject driving game screen showing the selection of insurance;

FIG. 5b discusses or educates the player as to insurance selection;

FIG. 6 illustrates a snapshot of the subject driving game screen showing the start of the game;

FIG. 7 illustrates a snapshot of the presentation of periodic questions displayed by the driving game;

FIG. 8 illustrates a snapshot screen concerning the example of speeding;

FIG. 9a illustrates a snapshot screen concerning more severe vehicular incidents;

FIG. 9b illustrates a snapshot screen concerning options involving the severe vehicular incidents; and

FIG. 10 illustrates online players and driving scores.

### DETAILED DESCRIPTION OF THE INVENTION

This invention is directed to an interactive driver's educational video game adapted to be used to educate drivers, particularly inexperienced drivers, on how to react in various driving situations in order to prevent automobile accidents and save lives. The interactive driver educational video game apparatus provides a simulated driving scenario displayed on a game picture. The interactive driver educational video game apparatus provides a driving game for a beginner driver to play on a computer or video game system that simulates driving scenarios to expose a driver to real life situations on the road. The Interactive driver educational video game apparatus better equips a young or inexperienced driver to react in driving scenarios that would likely be encountered in real world driving situations. It serves to protect the young driver as well as others on the road, and provides an elderly driver with an assessment of his/her reflexes, vision and/or hearing.

The interactive driver educational video game apparatus of the subject invention provides a driving game for a beginner driver to play on a computer or video game system that simulates a multitude of driving scenarios with the beginner behind the controls of a simulated car to expose him/her to real life situations on the road. The Interactive driver educational video game apparatus provides the ability for a young or inexperienced driver to become better equipped to react in driving scenarios encountered in real-world driving situations. In doing so, it protects young drivers as well as others on the road. Through use of the Interactive driver educational video game apparatus, inexperienced drivers have an opportunity to encounter real life driving scenarios before stepping into a car on their own. Although the Interactive driver educational video game apparatus is targeted for the younger generation, virtually all drivers can benefit from using it. Advantageously, the Interactive driver educational video game apparatus provides notification to caregivers and family members concerning a driver's strengths and weaknesses. For example, if a parent plays against their child, the results of the game can be utilized to inform the parent concerning the child's weaknesses and driving habits, thereby facilitating an assessment of the child's driving maturity. Based on the game score achieved, the parent can make an educated decision as to whether the child needs more advanced driver education courses. Substantially the same concept as to game play can be utilized to determine a senior driver's ability to drive safely. Implementing the Interactive driver educational video game apparatus allows a child or grandchild to determine whether their elderly relative is suffering from any type of age related driving impairments in a safe, non-aggressive, gentle manner. Preferably, the interactive driver educational video game apparatus includes a game-play test that directly measures vision and reflex responses.

The interactive driver educational video game apparatus is programmed with hundreds of driving scenarios that simulate real life driving experiences. Most common scenarios are implemented first. The game can be played alone or with combinations of from two-four players. Driving routes can be chosen in “real life” time-of-day and time-of-week, driving conditions, which may alternate from game to game. Vehicle type, such as car, truck, sports utility vehicles and/or motorcycle, can be chosen. Additionally, audio is provided, simulating cell phone ring tones, texting, talking and music. When played with friends or family, passengers are allowed to converse with each other as well as the driver. Cell phones can be used to call the driver, who must deal with cellular telephone calls as he/she would in a real situations. Simulating real life, the driver is prompted to enter the destination to which the driver will be traveling. The driver then attempts to drive to the destination without incident. Concentration is required during game play, and as the level of difficulty increases, more concentration and skills will be required. The game ends at the driver's destination or at a point as far as the driver is able to go without incident. At the end of the game, an incident report is generated by the game. For example, if the driver was speeding during the game, a ticket is issued. The cost of the ticket is set forth, as well as a notice of points on the driver's license, the number of years on the record, court mandatory drivers' classes, an increased insurance premium and an explanation to parents. Consequences also include minor accidents, major accidents, accidents where death or injury result, and the like. Minor accidents include for example, fender benders, parking lot bumps, mail box scrapes, property damage, etc. Consequences for minor accidents may include, a police report, being prompted to call the police, an insurance report, being prompted to call insurance company and explain accident, issuance of a ticket for careless or reckless driving, accumulated ticket costs/points on insurance, loss of car while in repair, out of pocket cost for repair, car rental if transportation is needed for school or work, insurance increase, payment for property damage, and the like. For major accidents, including hitting a deer, side swipe, head or rear end collisions, driving off the road, hitting a tree, etc., the game consequences are graver. Consequences to the driver may include one or more passengers being transported to the hospital, driver being transported to the hospital, meeting the parents/loved ones of the passengers whose lives the driver was in control of, tickets, insurance, loss of car, police report, and the like. Depending on which accident occurred, the speed at which the driver was driving will determine the severity of the injuries and consequences set forth in the game. The worst case scenario for a major accident is death. The lesson to be learned by the game driver includes a life lesson that it may not be the driver him/herself that is killed, but a passenger, friend, family member, cyclist, pedestrian, person in another vehicle, woman expecting a baby, sister, brother or parent, best friend, girl/boy friend, and the like.

Numerous game systems have been conventionally proposed and used, such as a system consisting of a special machine for home use and a television monitor, and a system consisting of a special machine for business use, a personal computer or a work station, a display, and a sound output machine. These systems include a controller adapted to be operated by a player, a recording medium for storing therein a game program data, a CPU for effecting control for the production of sounds and images on the basis of the game program data, a processor for producing images, a processor for producing sounds, a CRT for displaying images, and a speaker for outputting sounds. A CD-ROM, a semiconductor memory, a cassette containing a semiconductor memory, and the like are frequently used as the above computer readable recording medium.

Game players will be instructed how to navigate through the game. Preferably a small GPS or navigation system provided on the screen of the game informs players of where they are going and directions, etc. Optionally, the GPS can also be programmed and set by a controller or user to confuse or complicate decisions forcing a player to be more focused.

A player's game turn preferably starts with player A in a position; player B gets control after player A has successfully navigated through level in play. When the game is being played with multiple drivers, anyone after player A has a slight advantage if they are paying attention to the challenges of the first driver. The purpose of this game to teach and for its players to learn, so this slight advantage further facilitates this purpose. However players who compete will want an even field. Preferably levels will involve the same route with moderate changes so drivers expect the same challenges but don't know which ones have been changed. In addition, when player A in position makes a major mistake, once he acceptably finishes that level he is moved to the back seat and all players shift forward.

The game system further provides for teaching concerning use of, and importance of, a seatbelt. The game is designed to allow for players to reset seatbelts or not, via a seatbelt option means. After any traffic incident and between switching drivers, the seat belts preferably need to be reset. This will be the responsibility of the player (driver). Any incident a driver experiences without seatbelts set, results in more serious consequences in the game (to simulate real life).

Points and point score means are provided in the subject game. The points and point score means may be set based on a number of different bench marks, such as the player's age and/or driving experience level.

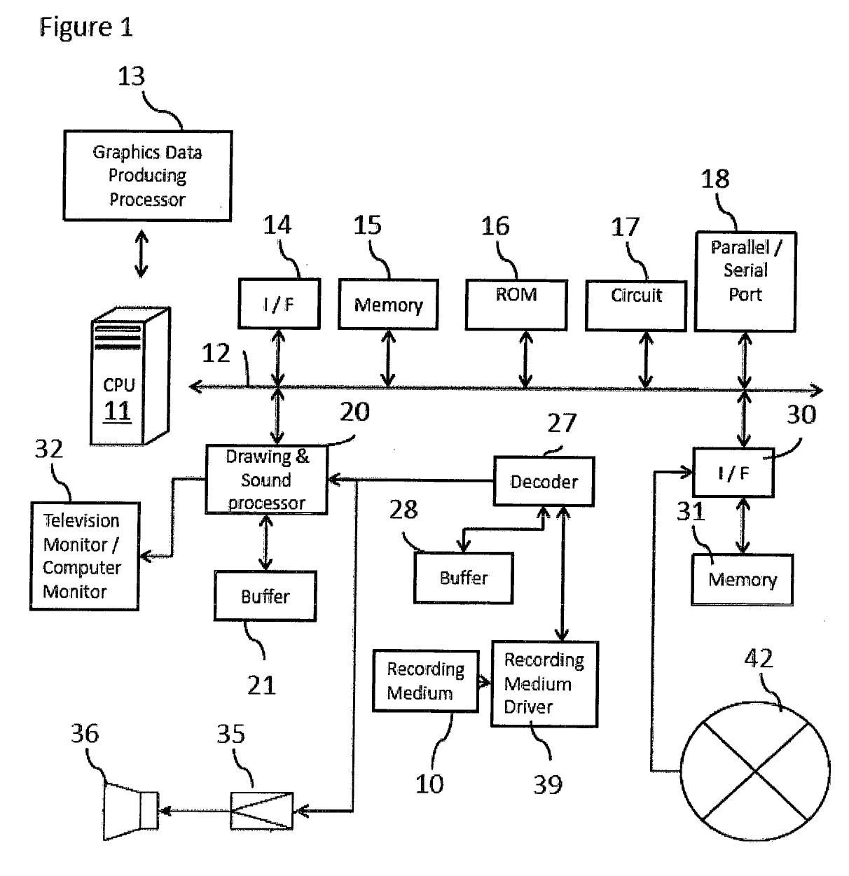

FIG. 1 is a block diagram showing a game system according to an embodiment of the present invention. Generally, the game system consists of a game machine a main body and a recording medium 10 storing program data therein. The game machine main body consists of a CPU 11, a bus 12 consisting of an address, data and a control bus that are connected to the CPU 11, and components connected to the bus 12. A graphics data producing processor 13, an interface circuit 14, a main memory 15, a ROM 16, an expanding circuit 17, a parallel port/serial port 18, a drawing and sound processor 20 and a buffer 21, a decoder 27 and a buffer 28, an interface circuit 30 and a memory 31 are connected to the bus 12. In addition, a television monitor 32 is connected to the drawing/sound processor 20, a speaker 36 is connected to the drawing/sound processor 20 via an amplifier 35, a recording medium driver 39 is connected to the decoder 27, and a memory 41 and a controller 42 are connected to the interface circuit 30. The form of the above game system varies with its use. When the above game system is constructed for home use, the television monitor (hereinafter, referred to as a “monitor”) 32 and the speaker 36 are separated from the game machine main body. When the above game system is constructed for business use, all the components shown in FIG. 1 are accommodated in a single integrated housing. When the above game system is constructed on the basis of a personal computer or a workstation, the monitor 32 corresponds to a computer display, the drawing processor, the sound processor, and the expanding circuit respectively correspond to a part of program data recorded in the recording medium or hardware on an expansion board mounted on an expansion slot of the computer, the interface circuit, the parallel port/serial port 9 and the interface circuit correspond to the hardware on the expansion board mounted on the expansion slot of the computer, and the buffers correspond to the main memory or each of areas of a non-illustrated extended memory.

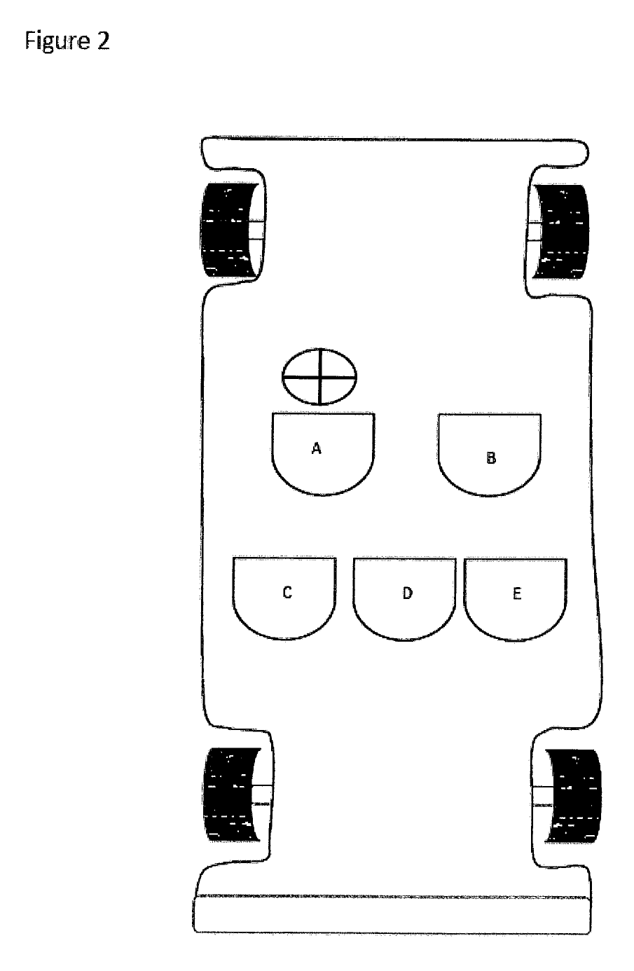

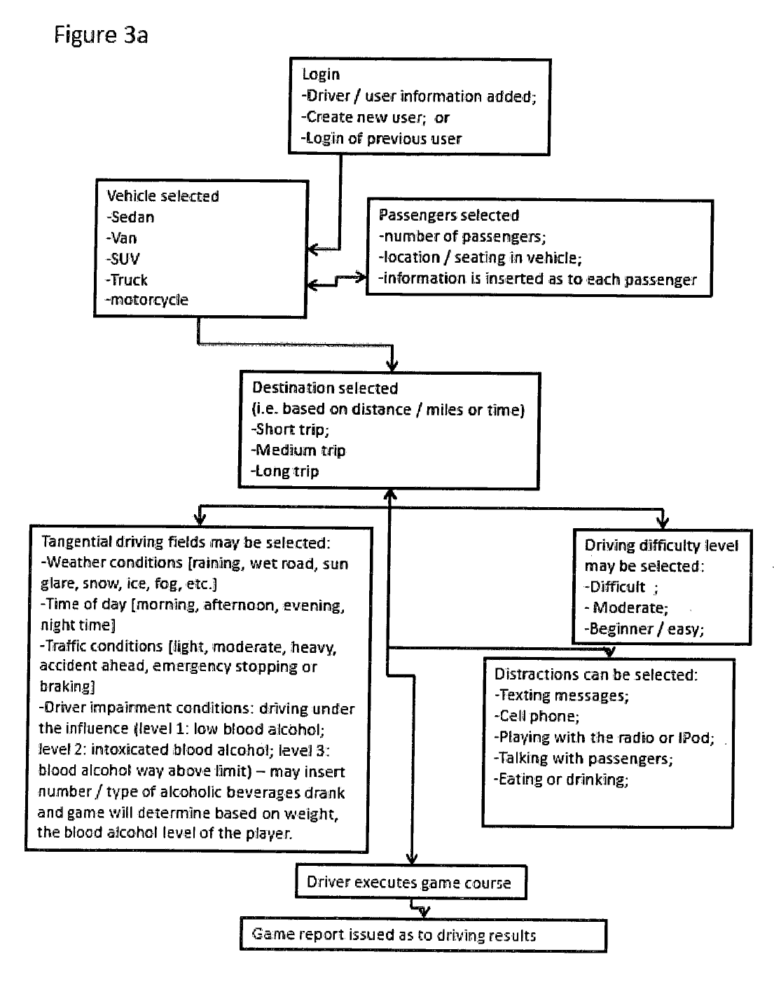

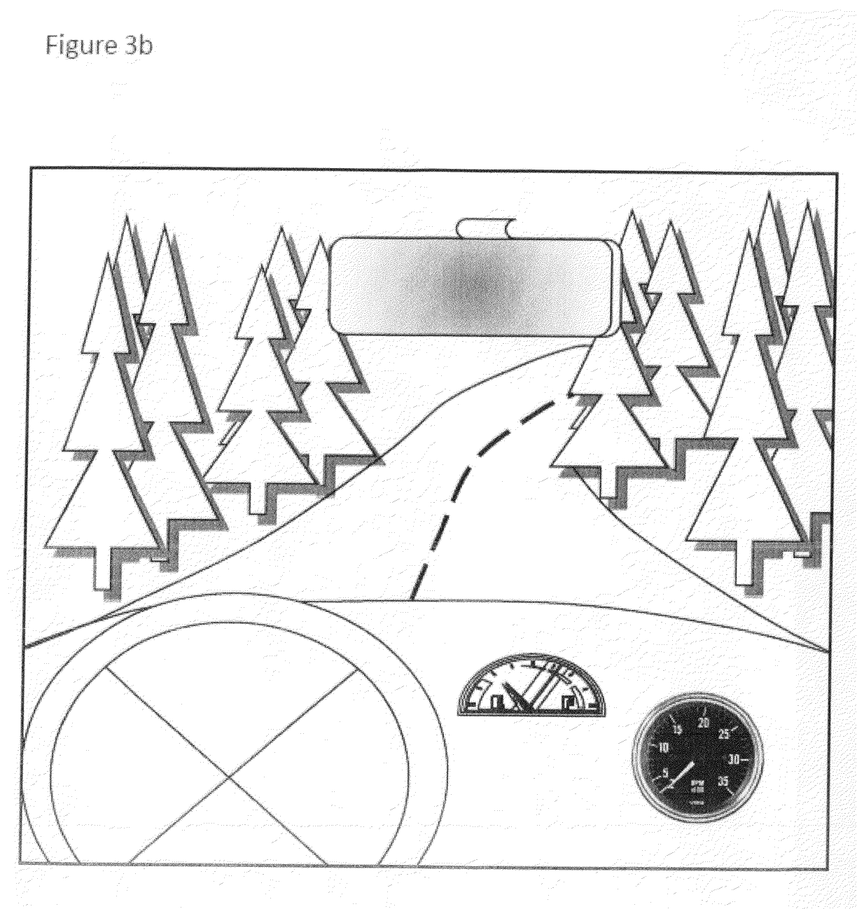

FIG. 2 illustrates a diagram of an embodiment of the subject invention wherein a passenger vehicle is provided. FIG. 3a illustrates a flow chart of an embodiment of game parameters; FIG. 3b illustrates a picture of the game. At the start of the game/a game log in the vehicle is selected, herein shown as a passenger vehicle car/SUV 101. Next, association between the players is established, including the driver A position, front passenger B position, diver rear C position, middle passenger rear D position and passenger side rear E position. Information as to driver and each of the passengers is inserted. Driver example: name John Miller, approximate age 20, approximate weight 162; passenger B, association to driver, age, etc, seatbelt on/off? Type of car is inserted—by selection from a list. Destination is then chosen: short trip 20 minutes; medium; long; type of destination: shopping mall, air port, etc. Game outline: once logged in, the user's information can be saved for game play/later game play and a number of different users can be entered into the game login system. Vehicle, passenger, destination information is entered. Game stops with incident report and provides delay period to reflect on what happened during the course of the game play. If incident was minor and car is capable; driver may continue or pass control of vehicle to driver in B position. If B position is chosen, so is new route as an option. At game end, if two or more people have played, the best driver is declared. The game determines possible ramifications based on factored statistics. Statistics are what will determine the outcome of an incident or driver error. Gender/weight/age and position in a car are all factored into the statistics. The statistics show the young driver that he/she lacks experience and can become entangled in a vehicle accident or incident, and the statistic warns parents of their child's weaknesses. In the gaming system, the road can be simulated so that if the driver hits a bump or drives onto the shoulder of the road a pulse is sent to the game controller and the driver immediately feels a pulse. The screen or display mimics what a driver sees from behind the wheel of the car/vehicle selected. Mirrors are also provided to reflect traffic conditions to the rear and sides of the car. Specifically, a rear mirror and or side mirrors are provided, as shown on the screen, that appear realistic and mimic cars, passed landscape of road, passengers in back, tailgaters, the police, or the like.

At the driver's discretion, a level or section can be provided which simulates blood alcohol levels, close to or over the legal limit. The game may be provided as a 3 D version. GPS technology can be implemented into the game to simulate real driving directions and/or real time traffic and driving conditions. Game play for elders may also be provided. Reflex of the player, as well as perhaps vision or hearing deficiencies, can be measured with use of the driving game. A player is appointed to log in on several different games and plays consecutively. After a predetermined number of times the game is played and/or period of time, the program can rate the driver's overall performance. The game can conclude with an opinion or suggest a change in behavior. The game may recommend vision and/or hearing testing, or set forth a finding as to the reflexes of the driver.

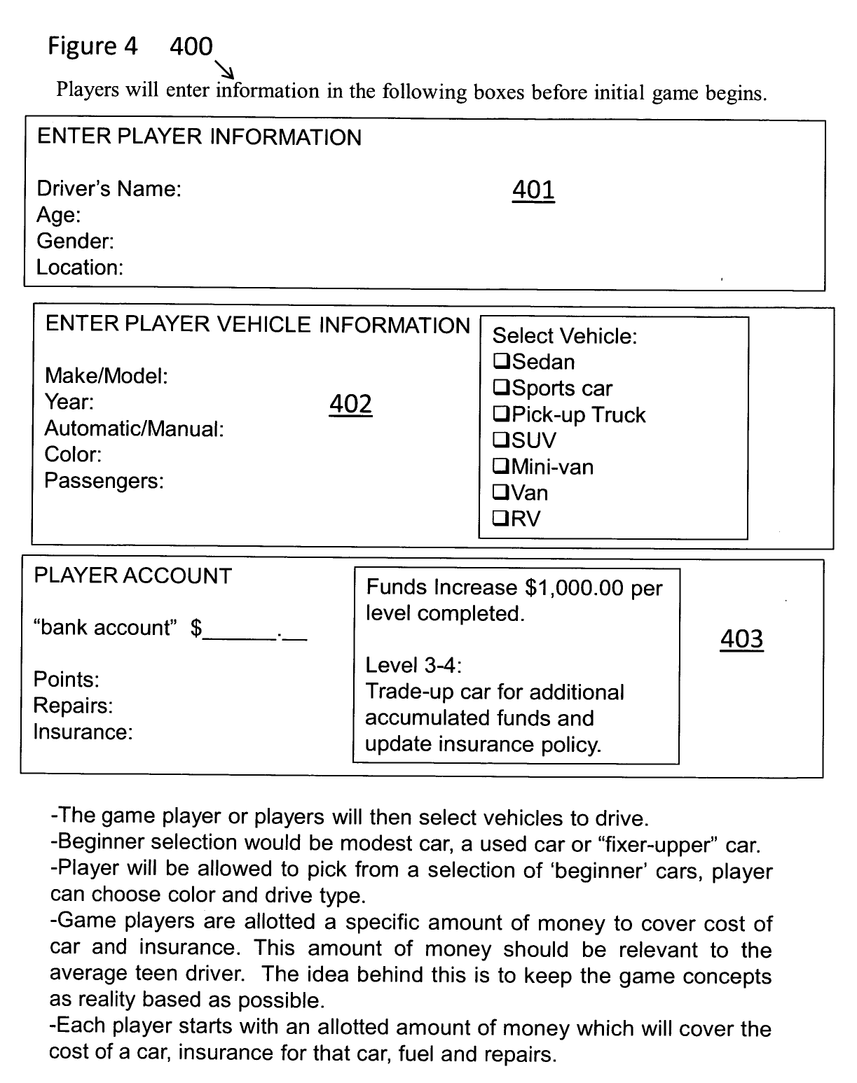

FIG. 4 illustrates a snapshot of the subject driving game screen, shown generally at 400. The player enters player information at 401. The game player or players will then select vehicles to drive at 402. Beginner selection could be a modest car, i.e. a used car or ‘fixer-upper’ car. P layer will be allowed to pick from a selection of ‘beginner’ cars, player can choose color and drive type. Game players are allotted a specific amount of money to cover the cost of car and insurance using the player account at 403. This amount of money should be relevant to the average teen driver. Each player starts with an allotted amount of money which will cover the cost of a car, insurance for that car, fuel and repairs. A “bank account” 403a may be included wherein a player receives an allowance deposited to bank at each level acceptably finished.

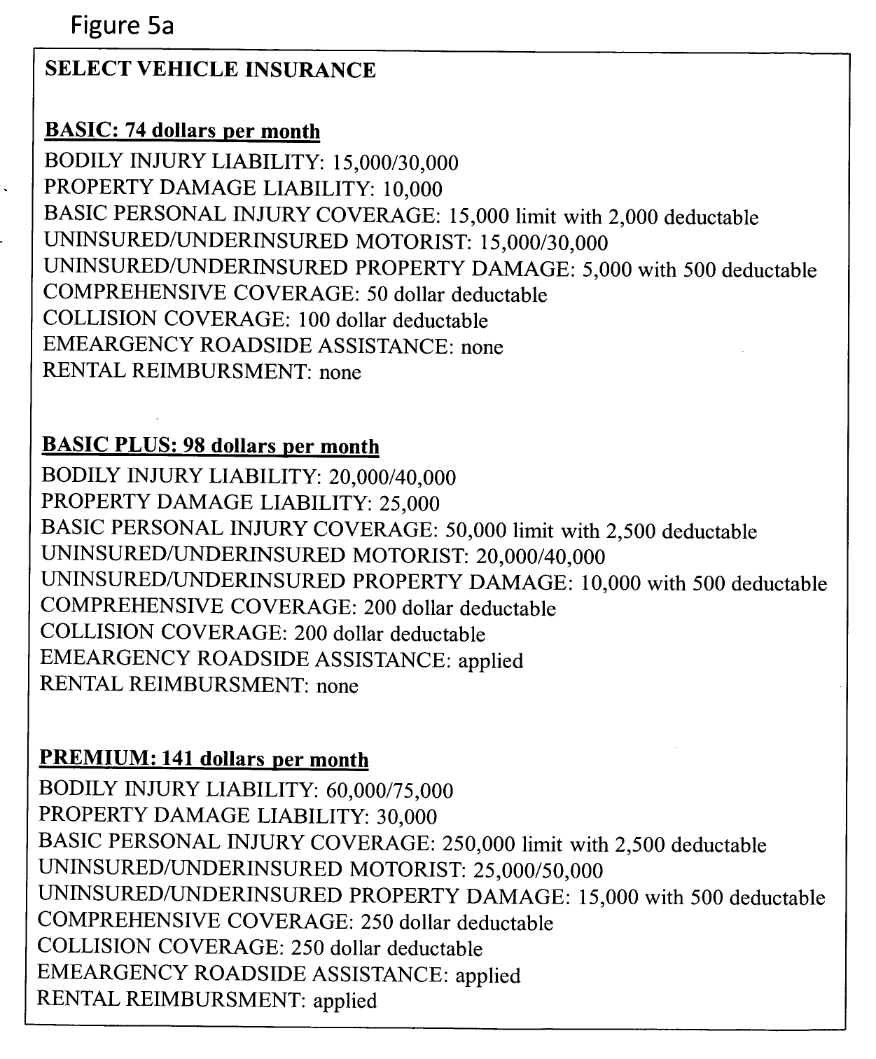

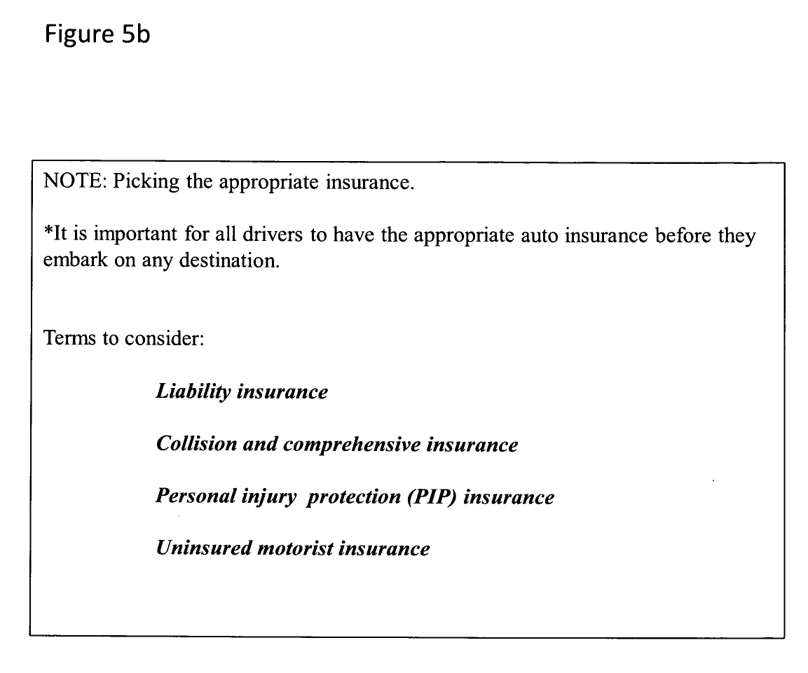

FIG. 5a illustrates a snapshot of the subject driving game screen showing the selection of insurance. FIG. 5b discusses or educates the player as to the insurance selection. At this step a player (s) must choose an insurance policy: Insurance policies are generally understood by anyone who drives, except inexperienced drivers. The player may choose between three policies. Some offer more protection than others. If a player chooses the less expensive policy they have extra money to upgrade their car at the end of every level. However, paying for a less expensive car insurance policy will require a player that is involved in an accident to pay out of pocket for excess damages, just like a driver would have to do in a real world situation.

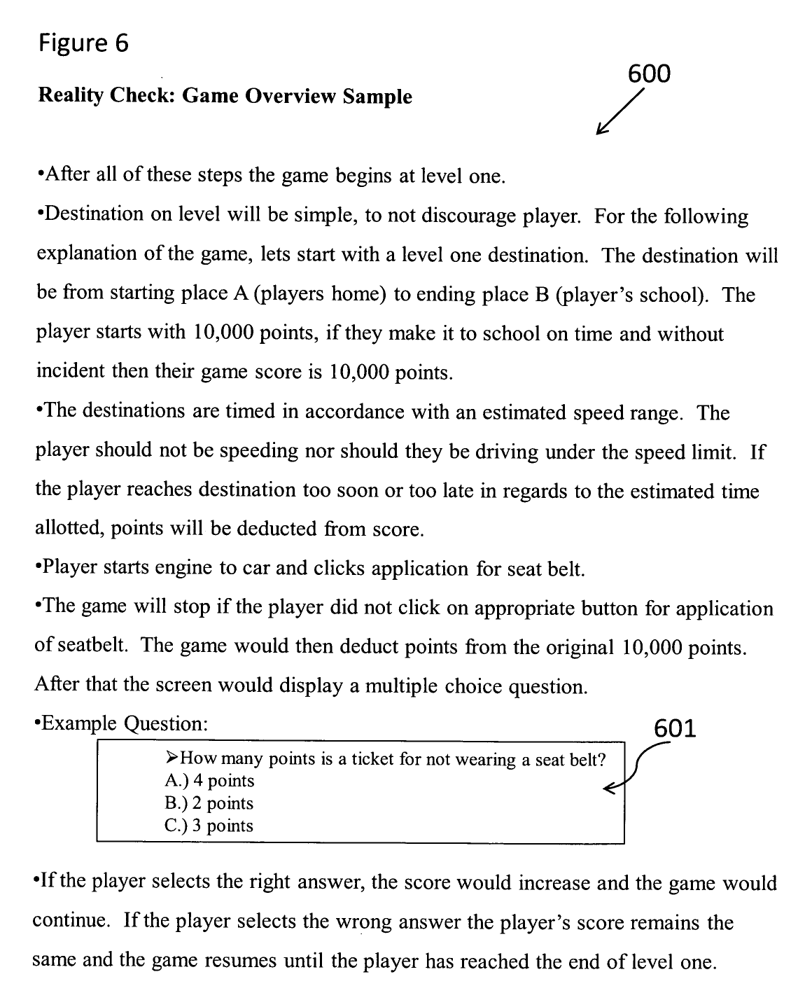

FIG. 6 illustrates a snapshot of the subject driving game screen showing the start of the game, shown generally at 600. After all of entry of information regarding the player, vehicle selection, etc., and insurance steps are complete, the game begins at level one. Destination on level one will be simple, to not discourage the player. For the following explanation of the game, let's start with a level one destination. The destination will be from starting place A (player's home) to ending place B (player's school). The player starts with 10,000 points, if they make it to school on time and without incident then their game score is 10,000 points. The destinations are timed in accordance with an estimated speed range. The player should not be speeding nor should they be driving under the speed limit. If a player reaches the destination too soon or too late in regards to the estimated time allotted, points will be deducted from the player's score. Player starts engine to car and clicks the application for seat belt. The game will stop if the player did not click on appropriate button for application of a seatbelt and the game preferably deducts points from the original 10,000 points. After that, the screen would display a multiple choice question as illustrated at 601. If the player selects the right answer to question 601, the score would increase and the game would continue. If the player selects the wrong answer the player's score remains the same and the game resumes until the player has reached the end of level one.

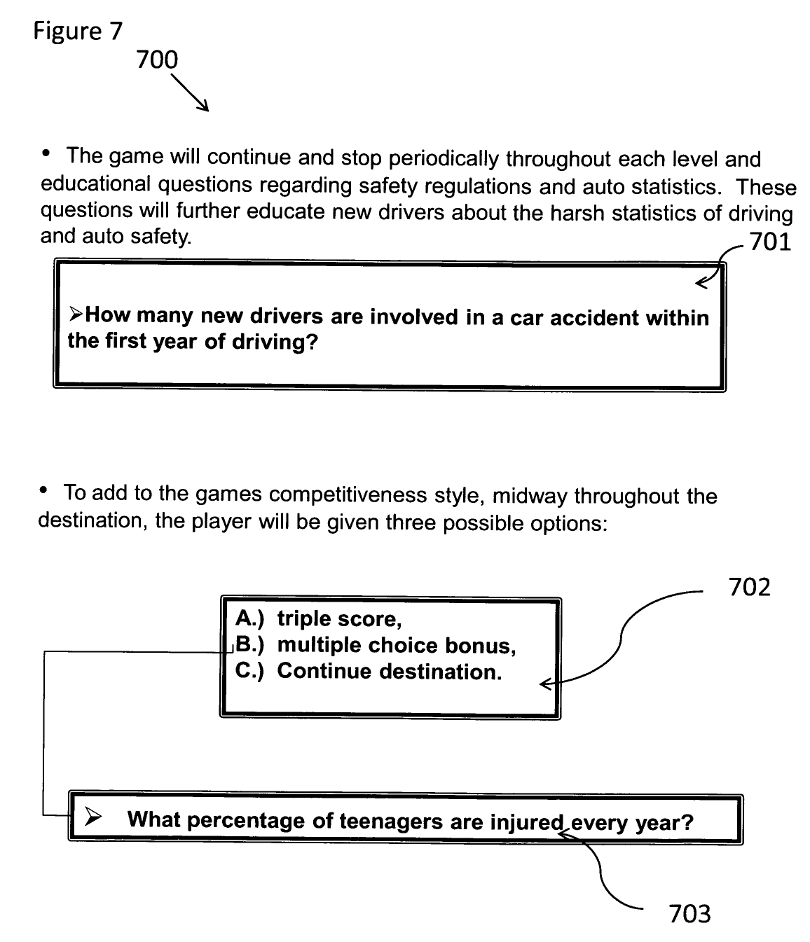

FIG. 7 illustrates a snapshot of the presentation of periodic questions displayed by the driving game, shown generally at 700. The game will continue and stop periodically throughout each level and educational questions regarding safety regulations and auto statistics as shown at 701. These questions will further educate new drivers about the harsh statistics of driving and auto safety. To add to the game's competiveness style, midway throughout the destination, the player is preferably given three possible options for scoring as shown at 702. Outcomes for Choosing Different Options: If player chooses A to question 702 they then jump to level 2 without finishing level 1. In the beginning of level 2 the player will select a destination, ie: a friend's house which is worth 20,000 points if completed without incident. This level can be completed with the exception that this driver has now taken the lead and that means that he/she cannot learn from their opponent's mistakes. This driver has gambled high score points to try and get ahead. If this player makes a mistake they return to the beginning of level 1. Preferably, the overall points score here is being used to eventually show that reaching a destination without incident is more important than getting there before everyone else. If player chooses B to question 702, a multiple choice question 703 will appear on screen, the possible points rewarded for a correct answer will be 500 points. The player can pick an answer; if the answer is correct, their score increases. If the player does not pick the correct answer their score stays the same. Afterwards, the game resumes and they continue to play. If the player chooses C: nothing happens; the player continues the game. The game ends when the player reaches a destination without incident. As players master each level they move on to the next level.

Players are encouraged to talk and interact with each other and the driver. (In teen accidents, 81% of the time teens were talking with each other when the accident occurred). Multiple Player Example: all players reach destination in level. All three scores will be different which affects how players change their strategies. Some players may feel they need to be more conservative to protect their position. Some will feel the need to gamble or possibly distract an opponent during the game. The game may include upgrades, possibly at some point in the game; players can choose new cars as a reward for doing well in the previous level. Players with upgrades pay for an insurance increase. The option to keep an existing car is allowed. As in a previous level, an insurance policy must be reviewed and selected.

Moving on to higher levels in the game: In the early levels the routes are simple with minor challenges. It should also be noted that the route stays the same, but the implemented events of the game change. For example, when a player is navigating to school and a deer jumps in front of the car, if the player was to replay that destination, the deer would likely not appear in the same place. This notion increases awareness and decreases prior knowledge about where particular incidents can/will occur. In real life, a driver does not get a heads-up before becoming involved in a car accident. Higher levels will have longer destinations. With longer destinations there will be a new set of expectations, such as checking coolant and tire pressure. At every preferably 3,000 mile mark, a reminder to check oil will flash across the screen. The game will provide opportunities to perform these actions. In addition, the player will use money from their allotted amount to complete these actions. Players must keep in mind the cost of repairs to their cars, as it is important to be aware and informed. It is also important to know how to budget for future events. Accidents in higher levels are more damaging.

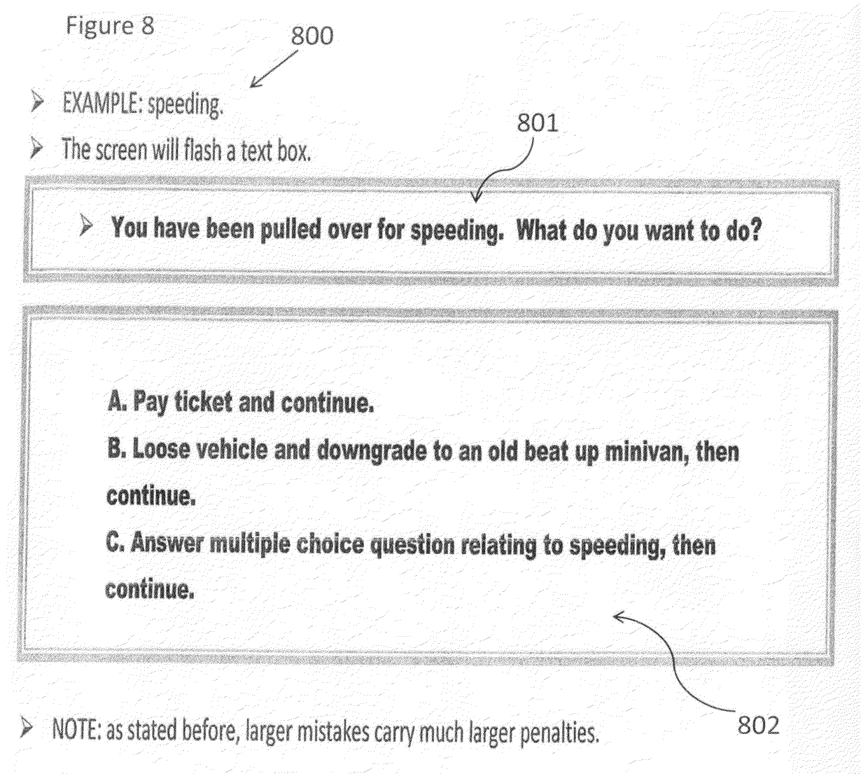

FIG. 8 illustrates a snapshot screen concerning the example of speeding, shown generally at 800. When a player is speeding, the screen will flash a text box as shown at 801 with options on how to address the ticket in box 802.

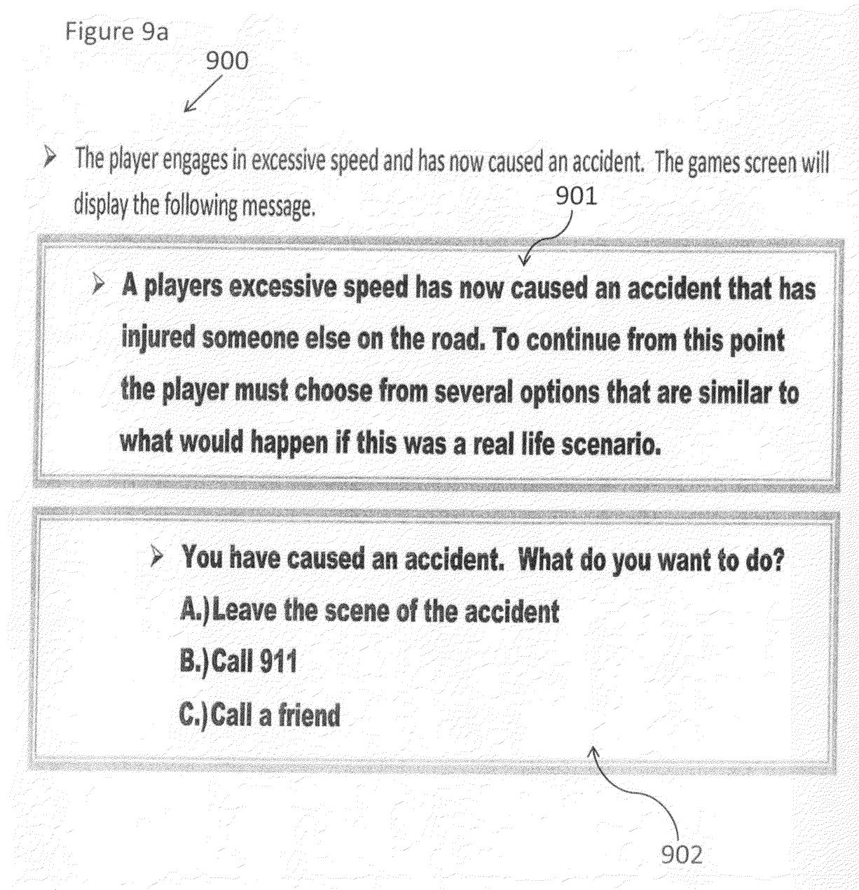

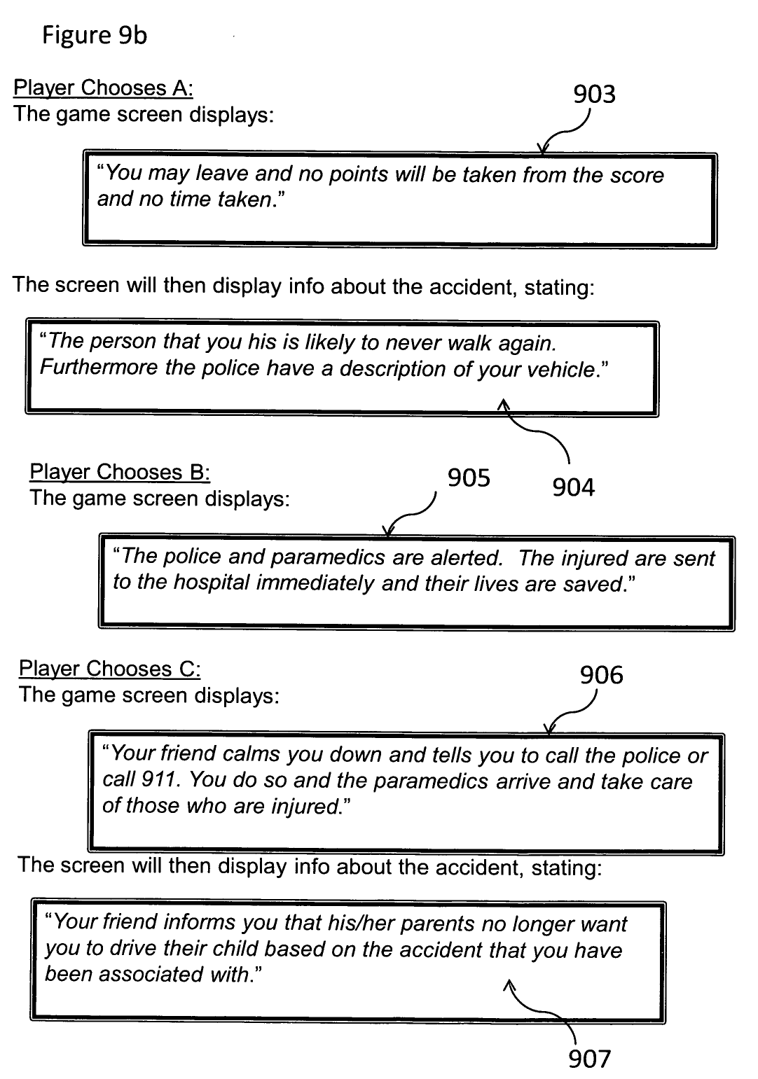

FIG. 9a illustrates a snapshot screen concerning more severe vehicular incidents, shown generally at 900. FIG. 9b illustrates a snapshot screen concerning options involving the severe vehicular incidents. If the player engages in excessive speed and causes an accident, the screen at 901 will appear with options on how to address the incident in box 902. If the player chooses A, leaving the scene, of 902 then the screen shown at 903 will appear. The screen will then display info about the accident and injuries as shown at 904 and the game continues. In the next level, the player will be pulled over and caught for leaving the accident, as a result, the player is downgraded several levels and has to start over from that level. If the player chooses B (call 911) of 902 then the screen shown at 905 will appear. Ramifications will be displayed, such as points deducted, insurance adjustments, car replacement. The player is forced to start back at the beginning of the level. If the player chooses C (call a friend) of 902 then the screen shown at 906 will appear and ramifications will also appear at 907. The game screen will display the ramifications of accident. The game screen also displays accident report, insurance adjustments and car replacement. The player resumes the game back at the start of the present level.

An overall game score can be achieved through testing of the game. This will serve as a bench mark to judge the scoring of the time and points necessary to reach each level. At some point it would be not only interesting but beneficial for these scores to be made public. Players are preferably given a rank among others who have played the game on a national spectrum by comparing the player's performance with others using Internet communication and transfer.

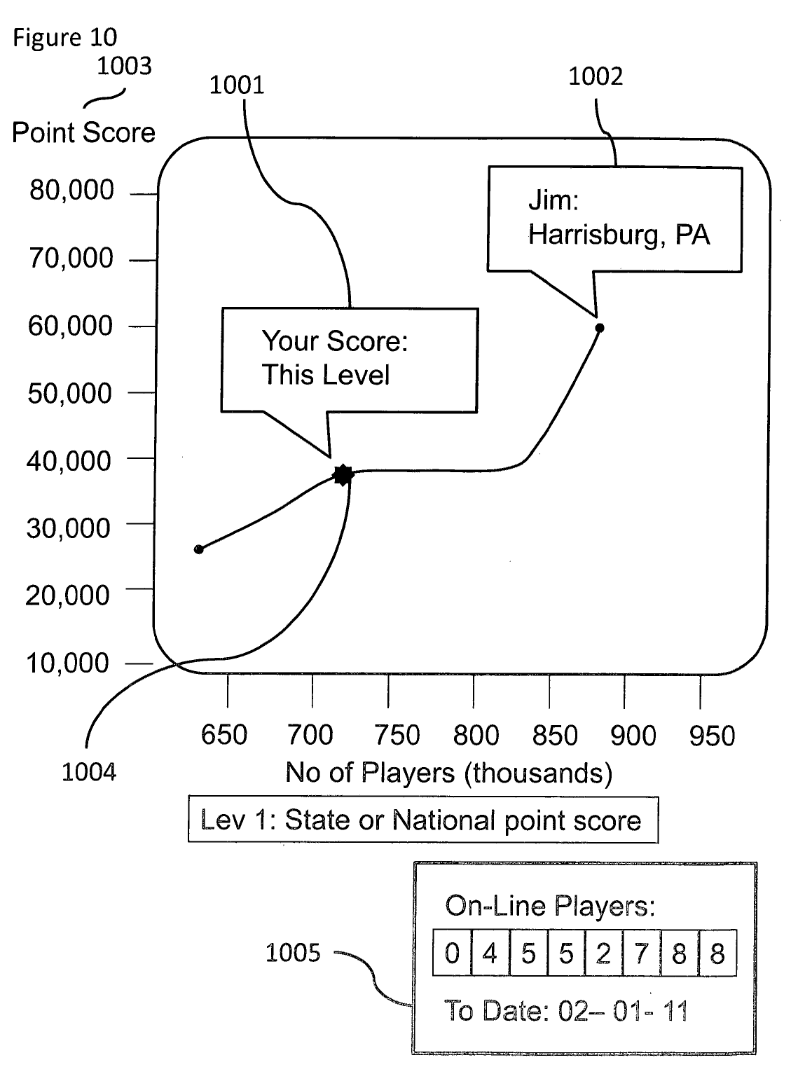

FIG. 10 illustrates online players and driving scores. The game may provide for online playing and communication through a broadband, Internet or other digital communication means wherein a driver's score 1001 is compared to other players, such as shown at 1002. The point score 1003 can be extrapolated against players as shown at 1004. Online data can be provided on the screen, showing the number of online players to date, as shown at 1005. With many games today, technology allows a gamer to play against himself/herself, or others who are connected via the Internet. Players can challenge one another based on direct scoring or on via state or national levels. This pits friends and teens everywhere against high scores and builds competitiveness so that teens absorb more of the game and the lessons it is geared to teach. Car insurance companies could capitalize on information from the game and players could become eligible for discounts in insurance, etc.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. An interactive driver's educational video game, comprising:
a. a game appointed to be utilized on a system, said system comprising a game machine main body and at least one recording medium for storing program data therein, said game machine main body comprising at least one CPU, at least one bus and components connected thereto, at least one graphics data producing processor, at least one interface circuit, a main memory, a ROM, at least one expanding circuit, at least one parallel port/serial port, at least one drawing sound processor, and at least one buffer, at least one decoder, said game machine being appointed to be connected to a visual display monitor;
b. said game stored on a medium;
c. said game comprising a player number entry means, player vehicle position means, player assignment means, variable insert means, and distance/destination means.

2. An interactive driver's educational video game as recited by claim 1 comprising vehicle selection means.

3. An interactive driver's educational video game as recited by claim 2, wherein said vehicle selection means provides ability to select a specific type of vehicle being driven in said game, and said vehicle is chosen from a group consisting of motorcycle, sports utility vehicle, pickup truck, car, station wagon, all-terrain vehicle, high end sports car, van, and commercial box truck.

4. An interactive driver's educational video game as recited by claim 1 comprising player assignment means.

5. An interactive driver's educational video game as recited by claim 4, wherein said player assignment means comprises setting of a driver's age, gender, height, weight, and driving skill level.

6. An interactive driver's educational video game as recited by claim 4, wherein said player assignment means comprises setting of a number of passengers in said vehicle, and setting of each of said passenger's age, gender, height, weight, and relationship to driver.

7. An interactive driver's educational video game as recited by claim 1 comprising variable insert means selected from a group consisting of seatbelt on/off, cell phone usage, food/eating, radio or technical component usage, and conversation distractions.

8. An interactive driver's educational video game as recited by claim 1 comprising variable insert means selected from a group consisting of road conditions, traffic conditions, daytime, nighttime, fog, snow, ice and rain conditions.

9. An interactive driver's educational video game as recited by claim 1 comprising distance or destination means.

10. An interactive driver's educational video game as recited by claim 9, wherein said distance or destination means comprises trip information comprising short trip, medium or long trip (distance).

11. An interactive driver's educational video game as recited by claim 1 comprising type of destination means.

12. An interactive driver's educational video game as recited by claim 11, wherein said type of destination means comprises shopping malls, air ports, city, small town, and crowded venues in general.

13. An interactive driver's educational video game as recited by claim 1 comprising mapping means adapted to manipulate game data to yield an incident report generated by incident report means.

14. An interactive driver's educational video game as recited by claim 13, wherein said incident report is preferably generated with a delay period to reflect on what happened during course of game play.

15. An interactive driver's educational video game as recited by claim 1 comprising road variable means wherein a road can be simulated so that there are bumps associated with a pulse or vibration means communicated to a game controller;

16. An interactive driver's educational video game as recited by claim 1 comprising blood alcohol level simulation means substantially representing legal limit blood alcohol levels.

17. An interactive driver's educational video game as recited by claim 1 comprising report generation means for reporting a rank or grade based on a player's driving skills.

18. An interactive driver's educational video game as recited by claim 1 comprising physical testing comprising vision testing, hearing testing, and motor reflex skill testing.

19. An interactive driver's educational video game, comprising:
a. a game appointed to be utilized on a game system;
b. said game comprising a player number entry means, player vehicle selection means, vehicle insurance selection means, player seat assignment means, variable insert means, and distance/destination means.

20. An interactive driver's educational video game method comprising the steps of:
a. constructing a game system, said system comprising a game machine main body and at least one recording medium for storing program data therein, said game machine main body comprising at least one CPU, at least one bus and components connected thereto, at least one graphics data producing processor, at least one interface circuit, a main memory, a ROM, at least one expanding circuit, at least one parallel port/serial port, at least one drawing sound processor, and at least one buffer, at least one decoder, said game machine being appointed to be connected to a visual display monitor;
b. programming said interactive driver's educational video game comprising a player number entry means, player vehicle position means, player assignment means, variable insert means, and distance/destination means; and
c. storing said interactive driver's educational video game on a medium.
